(19) United States
(12) Patent Application Publication
(10) Pub. No.: US 2010/0145974 A1
(43) Pub. Date: Jun. 10, 2010

(54) SYSTEM AND METHOD FOR MANAGING RECIPES USING AN ELECTRONIC DEVICE

(75) Inventor: CHIEN-AN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/549,502

(22) Filed: Aug. 28, 2009

(30) Foreign Application Priority Data
Dec. 4, 2008 (CN) 200810305960.3

(51) Int. Cl. G06F 17/30

(52) U.S. Cl. 707/759; 707/E17.108

(57) ABSTRACT

A method for managing recipes using an electronic device controls a camera unit to capture a label image of a food source, converts a description in the label image into text. The method further searches a storage in the electronic device for the recipes containing the text of the food source, displays the found recipes containing the text corresponding the food source on the user interface of the electronic device.

### BACKGROUND

1. Technical Field

Embodiments of the present disclosure relate to information management systems and methods, and particularly to a system and method for managing recipes using an electronic device.

2. Description of Related Art

Generally speaking, many people learn to cook by reading cookbooks or browsing recipes from the Internet. However, reading cookbooks is time consuming and wastes money, and browsing recipes from the Internet requires a computer connected to the Internet. Thus, it is difficult to review recipes when the cookbooks and the Internet are not accessible.

### BRIEF DESCRIPTION OF THE DRAWINGS

FIG. 1 is a block diagram of one embodiment of an electronic device comprising a recipes managing system.

FIG. 2 is a block diagram of one embodiment of function modules of the recipes managing system in FIG. 1.

FIG. 3 illustrates a flowchart of one embodiment of a method for managing recipes using an electronic device.

FIG. 4 is a block diagram of one embodiment of a recipe.

### DETAILED DESCRIPTION

All of the processes described below may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

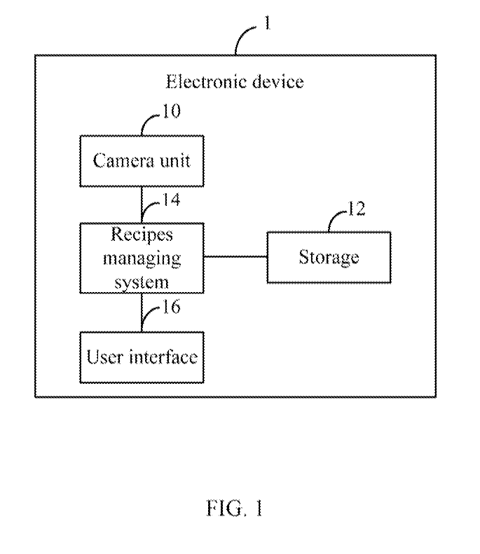

FIG. 1 is a block diagram of one embodiment of an electronic device 1. The electronic device 1 includes a camera unit 10, a storage 12, a recipes managing system 14, and a user interface 16.

The camera unit 10 obtains image information of food. In this exemplary embodiment, the camera unit 10 captures an label image of a food source. The label includes a description of the food source. The description in the label includes name of the food source, for example, tomato, potato, onion, chicken, pork, and beef.

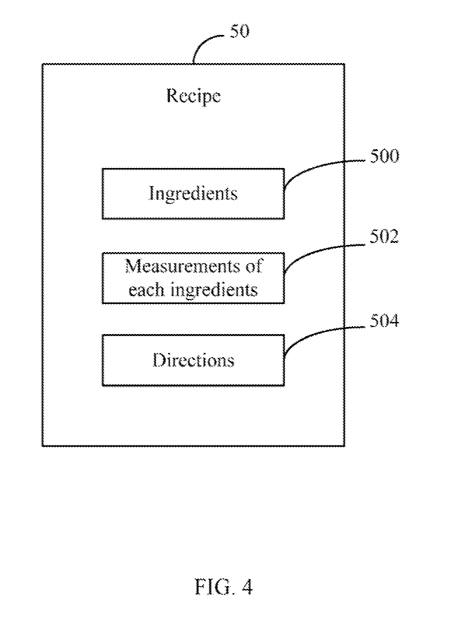

The storage 12 stores recipes in computer text format. In one embodiment, as show in FIG. 4, a recipe 50 includes ingredients 500, measurements of each ingredients 502, and directions 504. The ingredients 500 include name of each food source used in the recipe 50, for example, tomato. The measurements of each ingredients 502 include measurements of each food source used in the recipe 50, for example, two tomatoes. The directions 504 include a method for cooking according to the ingredients 500. The electronic device 1 may download new recipes from the Internet and store the new recipes to the storage 12. The computer text format, in one example, may be .TXT, .RTF, or .DOC.

The recipes managing system 14 controls the camera unit 10 of the electronic device 1 to capture a label image of a food source, converts a description in the label image into text, and searches the storage 12 in the electronic device 1 for the recipes containing the text of the food source.

The user interface 16 is operable to display found recipes containing the text.

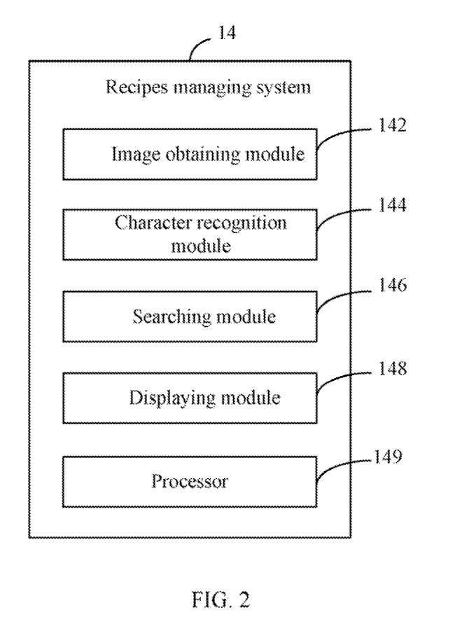

FIG. 2 is a block diagram of one embodiment of function modules of the recipes managing system 14 in FIG. 1. In one embodiment, the recipes managing system 14 includes an image obtaining module 142, a character recognition module 144, a searching module 146, and a displaying module 148. Depending on the embodiment, the electronic device 1 may include one or more specialized or general purpose processors, such as a processor 149 for executing at least one operation for the modules 142-148.

The image obtaining module 142 is operable to control the camera unit 10 to capture the label image of the food source. The label includes a description of the food source. The description in the label includes name of the food source. The label image may includes a picture area, a character area and a form area.

The character recognition module 144 is operable to convert the description in the label image into a text. In one embodiment, first, the character recognition module 144 analyzes the label image and identify the character area from the image; then, the character recognition module 144 converts characters in the character area into the text. The text includes name of the food source, for example, tomato.

The searching module 146 is operable to search the storage 12 for the recipes containing the text corresponding the food source.

The displaying module 148 is operable to display the found recipes containing the text corresponding the food source on the user interface 16 of the electronic device 1.

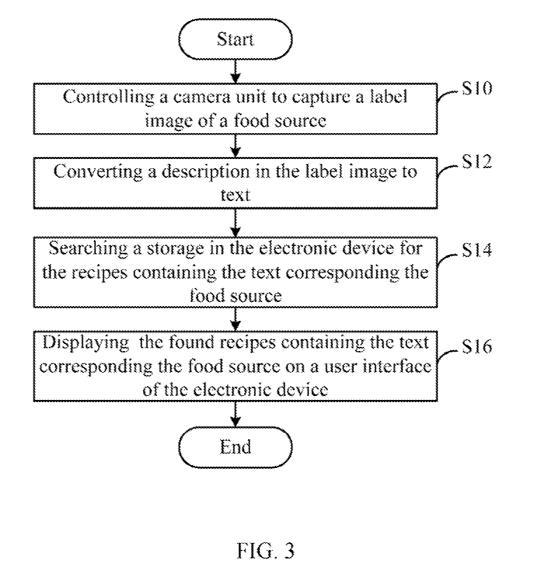

FIG. 3 illustrates a flowchart of one embodiment of a method for managing recipes using the electronic device 1. Depending on the embodiment, additional blocks may be added, others removed, and the ordering of the blocks may be changed.

In block S10, the image obtaining module 142 controls the camera unit 10 to capture the label image of the food source. The label includes a description of the food source. The description in the label includes name of the food source.

In block S12, the character recognition module 144 converts the description in the label image into a text. The text includes name of the food source, for example, tomato.

In block S14, the searching module 146 searches the storage 12 for the recipes containing the text corresponding the food source.

In block S16, the displaying module 148 displays the found recipes containing the text corresponding the food source on the user interface 16 of the electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for managing recipes using an electronic device, comprising:
at least one processor;
a storage that stores recipes, and one or more programs, the one or more programs comprising:
an image obtaining module operable to control a camera unit of the electronic device to capture a label image of a food source;
a character recognition module operable to convert a description in the label image into text; and
a searching module operable to search the storage for the recipes containing the text corresponding the food source.

2. The system of claim 1, further comprising a displaying module operable to display the found recipes containing the text corresponding the food source on a user interface of the electronic device.

3. The system of claim 1, wherein the description in the label comprises the name of the food source.

4. A method for managing recipes using an electronic device, the method comprising:
controlling a camera unit of the electronic device to capture a label image of a food source;
converting a description in the label image into text; and
searching a storage in the electronic device for the recipes containing the text corresponding the food source.

5. The method of claim 4, further comprising:
displaying the found recipes containing the text corresponding the food source on a user interface of the electronic device.

6. The method of claim 4, wherein the description in the label comprises the name of the food source.

7. A storage medium having stored thereon instructions that, when executed by a processor, causing the processor to perform a method for managing recipes using an electronic device, the method comprising:
controlling a camera unit of the electronic device to capture a label image of a food source;
converting a description in the label image into text; and
searching a storage in the electronic device for the recipes containing the text corresponding the food source.

8. The medium of claim 7, further comprising:
displaying the found recipes containing the text corresponding the food source on a user interface of the electronic device.

9. The medium of claim 7, wherein the description in the label comprises the name of the food source.
